(19) United States
(12) Patent Application Publication
(10) Pub. No.: US 2013/0036018 A1
(43) Pub. Date: Feb. 7, 2013

(54) CUSTOM DESIGNED ARTICLE VENDING MACHINE

(71) Applicant: Tamara Corinne Dickerson, Ft. Thomas, KY (US)

(72) Inventor: Tamara Corinne Dickerson, Ft. Thomas, KY (US)

(21) Appl. No.: 13/564,917

(22) Filed: Aug. 2, 2012

Related U.S. Application Data
(60) Provisional application No. 61/514,260, filed on Aug. 2, 2011.

(51) Int. Cl. G06Q 20/20

(52) U.S. Cl. 705/18; 705/16; 705/22

(57) ABSTRACT

A method of providing customized articles can include providing a kiosk. The kiosk can include a housing, a first user interface, an inventory, a printer, a drawer, and a computer, which can communicate with the first user interface, the inventory, the printer, and the drawer. The method further comprises the steps of receiving an order for a customized article, processing the order with the computer, transferring at least one article from the inventory to the printer, printing the user-selected design on the at least one article, and transferring the customized article to the drawer.

### CROSS REFERENCE TO RELATED APPLICATIONS

This application claims priority to U.S. Provisional Application No. 61/514,260 filed Aug. 2, 2011, which is incorporated herein by reference in its entirety.

### TECHNICAL FIELD

The present disclosure generally relates to a vending machine that provides interactive software for creating and printing custom designed articles.

### BACKGROUND

A custom designed article can be used as a form of personal expression, like a personal billboard. And at times, such custom designed articles can identify events, groups and interests. However, use of custom designed clothing, for example, is not as widespread as that of mass-marketed, branded products, as such branded products can be purchased with a relative degree of ease. Currently, options for obtaining custom designed clothing include printing at home or purchasing through online retailers and clothing printing service shops. Designing and printing such clothing at home can require a great deal of skill and/or expensive software or other equipment. Alternatively, long processing and/or delivery times can accompany purchasing such clothing through online retailers or clothing printing shops. Further, efficiency and cost-effectiveness can be concerns as such orders can involve several design decisions for relatively small orders.

### SUMMARY

In accordance with one embodiment, a method of providing customized articles can comprise the step of providing a kiosk. The kiosk can include a housing and a first user interface associated with the housing. The first user interface can be accessible from an exterior of the housing. The kiosk can further include an inventory including at least one article retained within the housing, a printer retained within the housing, a drawer associated with the housing, and a computer. The computer can be retained within the housing and configured to communicate with the first user interface, the inventory, the printer, and the drawer. The method can further comprise the steps of receiving an order for a customized article via the first user interface and processing the order with the computer. The method can also comprise the steps of transferring the at least one article from the inventory to the printer, printing a user-selected design on the at least one article, and transferring the customized article to the drawer.

In accordance with another embodiment, a method of providing customized apparel can comprise the step of providing a kiosk. The kiosk can include a housing and a first user interface associated with the housing. The first user interface can be accessible from an exterior of the housing. The kiosk can further include an inventory including at least one shirt retained within the housing, a printer retained within the housing, a loading dock, a heating device, where the heating device can be retained within the housing, a drawer associated with the housing, and a computer. The computer can be retained within the housing and can be configured to communicate with the first user interface, the inventory, the printer, the heating device, and the drawer. The method can further comprise the step of providing an interactive design software. The interactive design software can be configured to receive design input from a user to create a user-generated design. The method can also comprise the steps of receiving an order for a customized shirt from the interactive design software and processing the order with the computer. The order can include information relating to the user-generated design. The method can further comprise the steps of transferring the at least one shirt from the inventory to the printer, printing the user-generated design on the at least one shirt, curing the ink on the customized shirt with the heating device, and transferring the customized shirt to the drawer.

In accordance with yet another embodiment, a method of providing customized apparel can comprises the step of providing a kiosk. The kiosk can include a housing, a first user interface, and a second user interface. The first and second user interfaces can be associated with the housing and accessible from an exterior of the housing. The kiosk can further include an inventory including at least one Shirt retained within the housing and one or more weight-sensitive shelves. Each of the one or more weight-sensitive shelves can provide a reorder notice upon sensing a weight of that is less than a predetermined minimum shelf weight. The kiosk can also include a printer retained within the housing and including a loading dock, a heating device, the heating device retained within the housing, a drawer associated with the housing, and a computer. The computer can be retained within the housing and configured to communicate with the first user interface, the second user interface, the inventory, the printer, the heating device, and the drawer. The method can further comprise the step of providing access to an interactive design software at the first user interface. The interactive design software can be configured to receive design input from a user to create a user-generated design. The method can also comprise the step of reviewing the user-generated design. The interactive design software can ensure that the user-generated design is substantially free of objectionable material. The method can further comprise the step of accepting user payment. Each of the first and second user interfaces can be configured to accept user payment. The method can also comprise the steps of receiving an order for a customized shirt from the interactive design software and processing the order with the computer. The order can include information relating to the user-generated design. The method can further comprise the steps of organizing the order in an order queue, providing a user with an estimated waiting time, transferring the at least one shirt from the inventory to the printer, and printing the user-generated design on the at least one shirt. The method can also comprise the steps of curing the ink on the customized shirt with the heating device and transferring the customized shirt to a holding slot. The kiosk can further include a plurality of holding slots. The method can further comprise the steps of notifying a user when the customized shirt is available for pickup and transferring the customized shirt to the drawer. The drawer can be accessible to a user upon a user authorization. The second user interface can be configured to receive a user authorization for access to the drawer.

### BRIEF DESCRIPTION OF THE DRAWINGS

It is believed that certain embodiments will be better understood from the following description taken in conjunction with the accompanying drawings in which:

FIG. 1 is a flow chart of a method for providing apparel according to one embodiment.

FIG. 2 is a perspective view of a kiosk according to one embodiment, shown with a first user interface and a second user interface.

FIG. 3 is a cross-sectional perspective view of the kiosk of FIG. 1, along line 2-2, shown in association with the second user interface, a computer, a drawer, an inventory, holding slots, and a printer.

FIG. 4 is a cross-sectional view of the kiosk of FIG. 1, along line 3-3, shown in association with the computer, the drawer, the holding slots, and the second user interface.

FIG. 5 is a flow chart of a method for providing customized apparel according to one embodiment.

### DETAILED DESCRIPTION

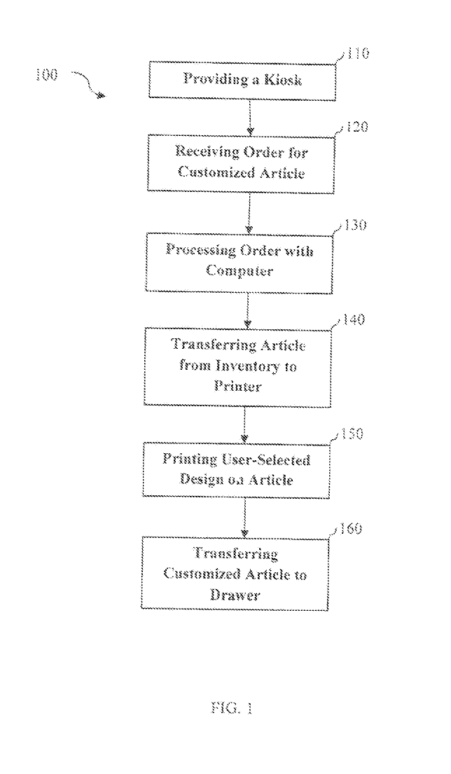

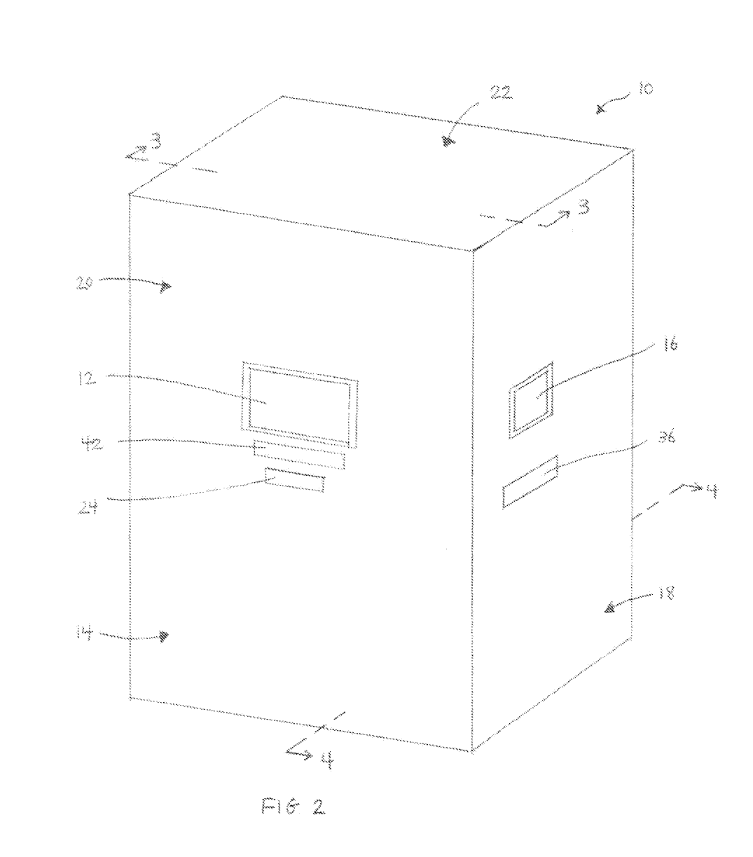

FIG. 1 shows a flow chart describing a method for providing apparel 100. As shown in FIG. 1, the method can include Providing a Kiosk 110. FIGS. 2-4 depict a kiosk 10 according to one embodiment. In certain embodiments, a kiosk 10 can include one or more user interfaces. In such embodiments, the one or more user interfaces can include digital touch screen displays at which a user can communicate with the kiosk 10 to, for example, submit an order for a customized article and/or shirt. As shown in FIG. 2, the kiosk 10 can include a first user interface 12 on a front wall 14 and a second user interface 16 on a first side wall 18, where both the first user interface 12 and the second user interface 14 can be accessible to a user from an exterior 20 of a housing 22. Though the second user interface 16 is depicted in FIGS. 2-4 to be positioned on the first side wall 18, it will be appreciated that a second user interface can be positioned on a back wall, an opposing side wall, or on a front wall along with a first user interface, such that separate users can each access one of the first and second user interfaces simultaneously.

The kiosk 10 can be a vending machine such that a user can complete a transaction by using, for example, the first user interface 12 and/or the second user interface 16 along with a payment device 24, which is shown in FIG. 2. In certain embodiments, the payment device 24 can include a credit card reader, where the credit card reader can also process, for example, a student identification card, and can be configured to accept cash payment.

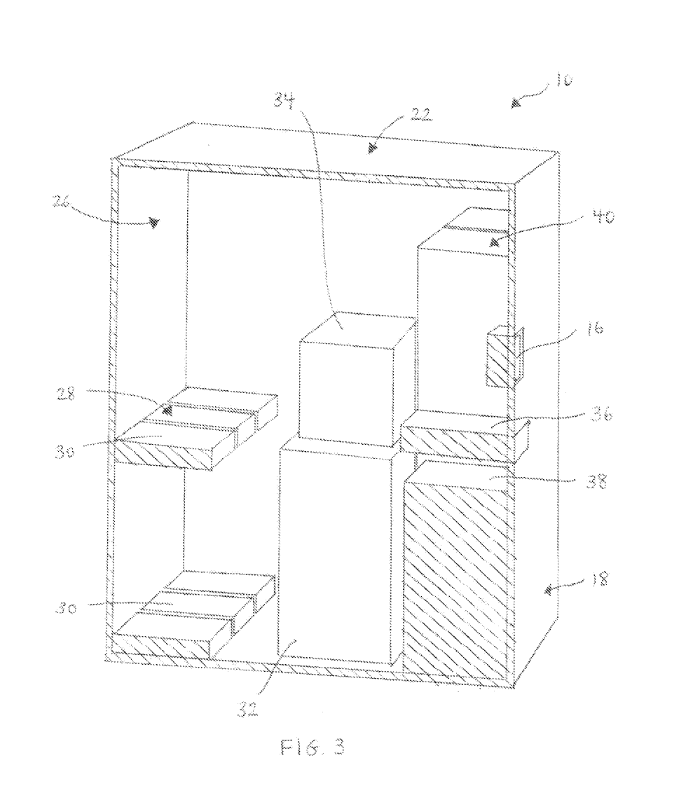

In an interior 26 of the housing 22, as shown in FIG. 3, the kiosk 10 can include an inventory 28, which can include one or more weight-sensitive shelves 30. In certain embodiments, the one or more weight-sensitive shelves 30 can be configured to store at least one article. FIG. 3 shows a storage box 32, in a center of the kiosk 10, substantially supporting a printer 34. In one embodiment, and as shown in FIG. 3, the storage box 32 can be substantially adjacent to the inventory 28 and the printer 34 such that articles can be restocked in the inventory 28 and ink can be supplied to printer 34 through the storage box 32. In certain embodiments, the printer 34 can include a loading dock, which can be configured to receive at least one article to be printed. In certain embodiments, the printer 34 can be a direct-to-garment textile printer, digital garment printer, inkjet printer, rotary screen printer, flat screen printer, or laser printer. Other suitable printing methods can include branding, stamping or other block printing methods, engraved copperplate printing, roller printing, stencil printing, and combinations thereof. Further, the kiosk 10 can be configured to apply etched, embroidered, and/or iron-on designs to articles.

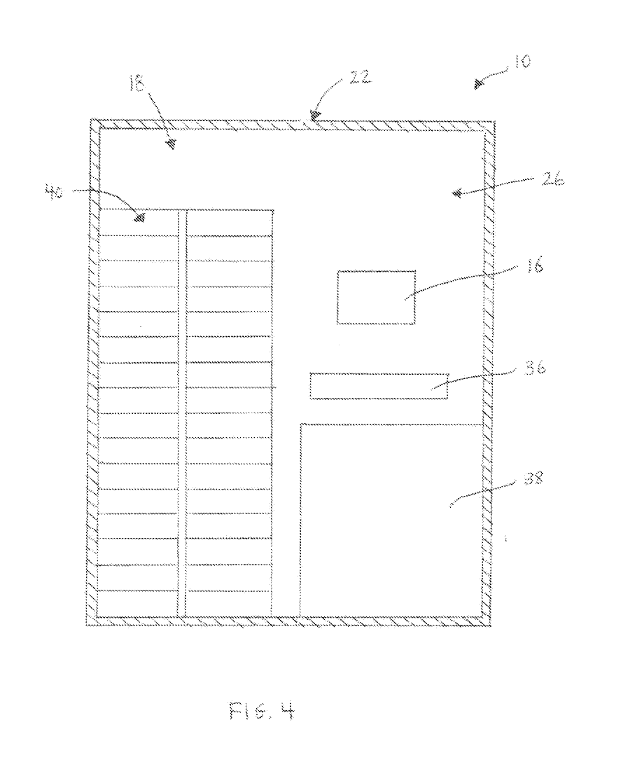

FIG. 4 depicts the first side wall 18 of the kiosk 10 from the interior 26 of the housing 22. In certain embodiments, a drawer 36 can be positioned on the first side wall 18 with the second user interface 16. As shown in FIGS. 2-4, the drawer 36 can be positioned below the second user interface 16, above a computer 38, and adjacent to a plurality of holding slots 40. In certain embodiments, the drawer 36 can be accessible to a user upon a user authorization, such that the drawer 36 can be unlocked to slidably extend from the housing 22. In such embodiments, the second user interface 16 can be configured to receive the user authorization for access to the drawer 36. In other embodiments, a kiosk can include two or more drawers. For example, in one embodiment, a first drawer can be positioned on a similar wall as a first user interface, such that the first user interface can be configured to receive a user authorization for access to the first drawer, and a second drawer can be positioned on a similar wall as a second user interface, such that the second user interface can be configured to receive a user authorization for access to the second drawer. As such, though the drawer 36 is depicted to be positioned on the first side wall 18 in FIGS. 2-4, it will be appreciated that a drawer can be positioned on any wall having a user interface.

As set forth above, and as shown in FIGS. 3-4, the drawer 36 can be positioned substantially adjacent to a plurality of holding slots 40. In certain embodiments, the holding slots 40 can be configured to receive customized articles and/or shirts, such that the customized articles and/or shirts can be stored until retrieved by a user. In such embodiments, the customized articles and/or shirts can be transferred from the holding slots 40 to the drawer 36 and can be accessible to a user therefrom upon a user authorization as described herein.

FIGS. 3-4 depict a computer 38 positioned within the interior 26 of the housing 22. In certain embodiments, a computer can be configured to communicate with various components within a kiosk including, for example, one or more user interfaces, an inventory, a printer, a drawer, and a heating device. Further, in certain embodiments, a computer can communicate wirelessly to devices outside of a kiosk including, for example, mobile devices, tablets, personal computers, and the like. Though the computer 38 is depicted to be positioned along the first side wall 18 and below the drawer 36 in FIGS. 3-4, it will be appreciated that a computer can be positioned at alternative locations within a kiosk.

As shown in FIG. 1, the method of providing customized articles 100 can further include Receiving Order for Customized Article 120. The computer 38 can be configured to receive an order. The order can include information relating to, for example, at least one article and a user-selected design. For example, in one embodiment, a user can create and submit an order by accessing the first user interface 12 and selecting, for example, the at least one article (i.e., an article to be customized) having a particular color, size, style, and/or additional feature and a design (e.g., a logo or user-created message) that can be applied to the at least one article. However, in certain embodiments, a user can submit an order at one or more user interfaces on a kiosk or from a remote location including, for example, a mobile phone, tablet, or personal computer, and the like. In certain embodiments, suitable examples of articles can include t-shirts, shorts, sweatshirts, sweatpants, infant bodysuits, jackets, hats, coffee mugs, plates, and clothing.

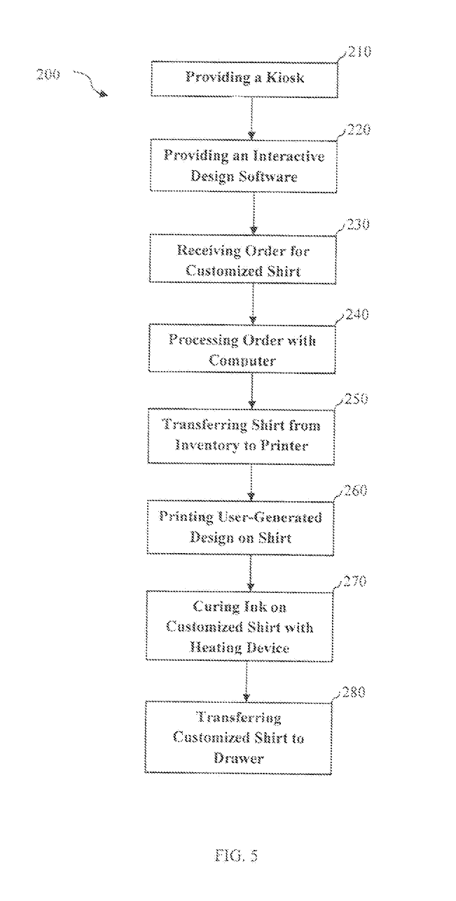

FIG. 5 shows a flow chart describing a method for providing customized apparel 200. Similar to the method for providing customized articles 100, and as shown in FIG. 5, the method for providing customized apparel 200 can include Providing a Kiosk 210 and Receiving Order for Customized Shirt 230, but the method for providing customized apparel 200 can further include Providing an Interactive Design Software 220. Thus, in certain embodiments, a kiosk 10 can be provided as depicted in FIGS. 2-4 and described herein, and further, access to an interactive design software can be provided at one or more user interfaces at the kiosk 10 or through a remote location such as, for example, a mobile phone application or website.

In certain embodiments, the interactive design software can be configured to receive design input from a user to create a user-generated design. For example, in one embodiment, the first user interface 12, as depicted in FIG. 2, can be configured to provide a user with access to the interactive design software. In such embodiments, the first user interface 12 can include a USB port, and the interactive design software can be configured to upload design input. Further, the first user interface 12 can include a scanner 42, and the interactive design software can be configured to scan design input. As such, design input can include previous user-created designs (e.g., artwork, graphics) uploaded and/or scanned to the interactive design software, designs selected from those existing on the interactive design software, and new designs created by a user through the interactive design software. In certain embodiments, the interactive design software can allow a user to add text to or otherwise modify or edit such uploaded, scanned, existing, or newly-created designs to customize a user-generated design. It will be appreciated that the interactive design software can be configured to upload and/or scan design input through a remote location.

In certain embodiments of each of the methods 100, 200 described in FIGS. 1 and 5, the computer 38 can communicate with the inventory 28 to detect availability of the at least one article and/or shirt within the inventory 28, taking into consideration articles and/or shirts committed to pending orders. In such embodiments, the computer 38 can notify a user through, for example, the first user interface 12 to provide an opportunity for a user to select a different article and/or shirt. In one such embodiment, the interactive design software can provide notification to a user, such that the computer 38 can be configured to communicate with the interactive design software. In certain embodiments, each of the one or more weight-sensitive shelves 30 can provide a reorder notice to the computer 38 upon detecting that the inventory 28 needs to restock one or more types of articles and/or shirts. In one embodiment, the one or more weight-sensitive shelves 30 can provide a reorder notice to the computer 38 upon sensing a weight that is less than a predetermined minimum shelf weight. A reorder notice can be sent from the computer 38 to a kiosk administrator.

In certain embodiments of the method of providing customized apparel 200, before submitting the user-generated design, the interactive design software can provide a user with an opportunity to review the user-generated design. In certain embodiments, the interactive design software can review the user-generated design to ensure that the user-generated design is substantially free of objectionable material including, for example, unsuitable language and copyrighted material.

For either of the methods 100, 200, before an order is placed, a user can be prompted to create a user account or log in to an existing account. In such embodiments, the user can be further prompted to provide a user identification name and password, approval of terms and conditions, and personal information including, for example, an email address. Through the user account, a user can access draft designs and saved images and provide access for other users to view and print their designs. A user's activity can be tracked to, for example, address a user's breach of the terms and conditions and/or failure to retrieve a customized article or shirt. In one embodiment, a breach of the terms and conditions can result in a user's order being denied. Further, in certain embodiments, payment can be required prior to an order submission. In such embodiments, each of the one or more user interfaces can be configured to accept user payment. As shown in FIG. 2 and described herein, the payment device 24 can be configured to accept user payment. In such embodiments, the payment device 24 can include a credit card reader. where the credit card reader can also process, for example, a student identification card, and can be configured to accept cash payment.

Upon receiving an order, both methods 100, 200 can include Processing Order with Computer 130, 240. In certain embodiments, upon receiving an order, the computer 38 can organize the order in an order queue. For example, orders can be organized in the order queue chronologically according to a time an order is received by the computer 38. In such embodiments, the computer 38 can organize orders received through a user interface at the kiosk 10 and from a remote location. In certain embodiments, upon organizing an order in an order queue, the computer 38 can provide a user with an estimated waiting time. In one such embodiment, upon providing a user at the kiosk 10 with an estimated waiting time, the first user interface 12 can prompt a user to select whether a user will wait to retrieve a customized article and/or shirt upon completion or pick up the customized article and/or shirt at a later time.

Once an order has been processed, the method for providing customized articles 100 can include Transferring Article from Inventory to Printer 140, and similarly, the method for providing customized apparel 200 can include Transferring Shirt from Inventory to Printer 250. In certain embodiments, a kiosk can further include a transfer mechanism that can deliver at least one article and/or shirt to a printer. In certain embodiments, a transfer mechanism can be contemplated for one or a plurality of articles that can include, for example, a robotic arm, which can grasp and move at least one article and/or shirt or a tray or case holding at least one article and/or shirt to the printer, an animatic robot with a smart motor, a conveyor belt, a horizontal carousel, or a trap door. In certain embodiments, at least one article and/or shirt can be positioned on a tray or in a case to facilitate transfer or printing of the at least one article and/or shirt. Further, the at least one article and/or shirt can be supported by a cardboard insert to provide additional stability throughout processing. In certain embodiments, the printer can include a printer loading dock, which can be configured to receive the at least one article and/or shirt from the transfer mechanism.

The printer 34, as shown in FIG. 3, can apply ink to at least one article for Printing User-Selected Design on Article 150, or for the method of providing customized apparel 200, at least one shirt for Printing User-Generated Design on Shirt 260. In certain embodiments, the printer 34 can receive the at least one article and/or shirt from the printer loading dock prior to printing. Further, the printer 34 can be configured to receive a user-selected and/or user-generated design from the computer 38. In the method 100 described in FIG. 1, the user-selected design can be printed on the at least one article to create a customized shirt. Similarly, in the method 200 described in FIG. 5, the user-generated design can be printed on the at least one shirt to create a customized shirt. As described herein, the printer 34 can be a direct-to-garment textile printer, digital garment printer, inkjet printer, rotary screen printer, flat screen printer, or laser printer. Further, the ink can be wear and color fade resistant textile ink.

With printing completed, in certain embodiments, the customized article or shirt can be transferred from the printer 34 to a heating device by, for example, a robotic arm, an animatic robot with a smart motor, a conveyor belt, a horizontal carousel, or a trap door. However, in other embodiments, the heating device can be positioned substantially adjacent to the customized article and/or shirt. In certain embodiments, the heating device can cure the ink on the customized article and/or shirt. For example, the method of providing customized apparel 200 can include Curing Ink on Customized Shirt with Heating Device 270. In such embodiments, the heating device can be any of a heat press, a heat lamp, an air dryer, or the like.

The method of providing customized articles 100 can further include Transferring Customized Article to Drawer 160, or for the method of providing customized apparel 200, Transferring Customized Shirt to Drawer 270. In certain embodiments, the customized article or shirt can be transferred from a curing location to the drawer 36 by, for example, a robotic arm, animatic robot with a smart motor, or other transfer mechanism as described herein, such that the drawer 36, with the customized article or shirt, can be accessible to a user upon a user authorization. In certain embodiments, the customized article or shirt can be transferred from a curing location to one of the plurality of holding slots 40, such that the customized article or shirt can be stored until retrieved by a user. As described above, in such embodiments, the customized article or shirt can be transferred from the holding slots 40 to the drawer 36 and be accessible to a user therefrom upon a user authorization. In one embodiment, the user authorization can be performed by a user providing user account information (e.g., user identification name and password) and/or a credit card swipe at, for example, the second user interface 16. In certain embodiments, the computer 38 can notify a user when the customized article and/or shirt are available for pickup. In such embodiments, the computer 38 can send, for example, an email or text message to a user indicating that the customized article and/or shirt is available for pickup.

In certain embodiments, the kiosk 10 can include one or more access doors at which unclaimed customized articles and/or shirts can be removed from the holding slots 40. Removal of the unclaimed customized articles and/or shirts can be necessary to allow for space in the holding slots 40. A time period for retrieving a customized articles and/or shirt from the kiosk 10 can be specified in, for example, the terms and conditions and/or an order confirmation email. In certain embodiments, the one or more access doors can also provide access to maintain the kiosk 10 and resolve any technical issues.

In certain embodiments, the housing 22 of the kiosk 10 can be constructed of any of a variety of materials including, but not limited to, wood, metal, plastics, composites, glass, or other suitable materials. Further, for the methods described herein, the kiosk 10 can be portable, such that it can be transported to any variety of locations. In addition to those items listed herein, other suitable examples of articles can include cell phone covers; laptop covers and cases; decals and clings for walls, cars, and windows; clutches; wallets; aprons; mouse pads; textiles; posters; flyers; announcements; programs; table tents; postcards; brochures; business cards; newsletters; stationary; pictures; cards; banners; labels; stickers; magnets; scrap-booking pages; picture frames and albums; and coupons.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art.

What is claimed is:

1. A method of providing customized articles comprising:
providing a kiosk, the kiosk including;
(a) a housing;
(b) a first user interface associated with the housing, wherein the first user interface is accessible from an exterior of the housing;
(c) an inventory, the inventory including at least one article retained within the housing;
(d) a printer, wherein the printer is retained within the housing;
(e) a drawer associated with the housing; and
(f) a computer, the computer being retained within the housing and configured to communicate with the first user interface, the inventory, the printer, and the drawer;
receiving an order for a customized article via the first user interface;
processing the order with the computer;
transferring the at least one article from the inventory to the printer;
printing a user-selected design on the at least one article;
transferring the customized article to the drawer.

2. The method of claim I, wherein the article is selected from the group consisting of t-shirts, shorts, sweatshirts, sweatpants, infant bodysuits, jackets, hats, coffee mugs, plates, and clothing.

3. The method of claim 1, wherein the kiosk includes a second user interface.

4. The method of claim 3, wherein the second user interface is configured to receive a user authorization for access to the drawer.

5. The method of claim I, further comprising the step of notifying a user when the customized article is available for pickup.

6. The method of claim 1, further comprising the step of transferring the customized article to a holding slot, wherein the kiosk further includes a plurality of holding slots.

7. The method of claim 1, wherein the computer is configured to receive the order through one or more user interfaces.

8. The method of claim 1, wherein the computer is configured to receive the order through a remote location.

9. The method of claim 1, wherein the inventory includes one or more weight-sensitive shelves, wherein each of the one or more weight-sensitive shelves provides a reorder notice upon sensing a weight that is less than a predetermined minimum shelf weight.

10. A method of providing customized apparel comprising:
providing a kiosk, the kiosk including;
(a) a housing;
(b) a first user interface associated with the housing, wherein the first user interface is accessible from an exterior of the housing;
(c) an inventory, the inventory including at least one shirt retained within the housing;
(c) a printer, the printer retained within the housing and including a loading dock;
(d) a heating device, the heating device retained within the housing;
(e) a drawer associated with the housing; and
(f) a computer, the computer being retained within the housing and configured to communicate with the first user interface, the inventory, the printer, the heating device, and the drawer;
providing an interactive design software, the interactive design software being configured to receive design input from a user to create a user-generated design;
receiving an order for a customized shirt from the interactive design software, wherein the order includes information relating to the user-generated design;
processing the order with the computer;
transferring the at least one shirt from the inventory to the printer;
printing the user-generated design on the at least one shirt;
curing the ink on the customized shirt with the heating device; and
transferring the customized shirt to the drawer.

11. The method of claim 10, wherein the first user interface is configured to provide a user with access to the interactive design software.

12. The method of claim 11, wherein the order is submitted through the first user interface.

13. The method of claim 11, wherein the first user interface includes a USB port, and wherein the interactive design software is configured to upload design input.

14. The method of claim 11, wherein the first user interface includes a scanner, and wherein the interactive design software is configured to scan design input.

15. The method of claim 11, wherein the kiosk further includes a second user interface, the second user interface being configured to receive a user authorization for access to the drawer.

16. The method of claim 10, wherein access to the interactive design software is provided through a remote location, such that the order is completed through a remote location and the computer is configured to receive the order through a remote location.

17. The method of claim 10, further comprising the step of notifying a user when the customized shirt is available for pickup.

18. The method of claim 10, further comprising the step of transferring the customized shirt to a holding slot, wherein the kiosk further includes a plurality of holding slots.

19. The method of claim 10, wherein the inventory includes one or more weight-sensitive shelves, wherein each of the one or more weight-sensitive shelves provides a reorder notice upon sensing a weight that is less than a predetermined minimum shelf weight.

20. A method of providing customized apparel comprising:
providing a kiosk, the kiosk including;
(a) a first user interface associated with the housing, wherein the first user interface is accessible from an exterior of the housing;
(b) a second user interface associated with the housing, wherein the second user interface is accessible from the exterior of the housing;
(c) an inventory, the inventory including at least one shirt retained within the housing and one or more weight-sensitive shelves, wherein each of the one or more weight-sensitive shelves provides a reorder notice upon sensing a weight that is less than a predetermined minimum shelf weight;
(d) a printer, the printer retained within the housing and including a loading dock;
(e) a heating device, the heating device retained within the housing;
(f) a drawer; and
(g) a computer, the computer being retained with the housing and configured to communicate with the first user interface, the second user interface, the inventory, the printer, the heating device, and the drawer;
providing access to an interactive design software at the first user interface, the interactive design software being configured to receive design input from a user to create a user-generated design;
reviewing the user-generated design, wherein the interactive design software ensures that the user-generated design is substantially free of objectionable material;
accepting user payment, wherein each of the first and second user interfaces is configured to accept user payment;
receiving an order for a customized shirt from the interactive design software, wherein the order includes information relating to the user-generated design;
organizing the order in an order queue;
providing a user with an estimated waiting time;
processing the order with the computer;
transferring the at least one shirt from the inventory to the printer;
printing the user-generated design on the at least one shirt;
curing the ink on the customized shirt with the heating device;
transferring the customized shirt to a holding slot, wherein the kiosk further includes a plurality of holding slots;
notifying a user when the customized shirt is available for pickup; and
transferring the customized shirt to the drawer, wherein the drawer is accessible to a user upon a user authorization, and wherein the second user interface is configured to receive a user authorization for access to the drawer.
